(19) United States
(12) Patent Application Publication
(10) Pub. No.: US 2006/0055812 A1
(43) Pub. Date: Mar. 16, 2006

(54) Optical equipment having image pickup element

(76) Inventors: Tatsuo Takanashi, Tokyo (JP); Hiroaki Miyasho, Tokyo (JP); Motoaki Kobayashi, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/209,225

(22) Filed: Aug. 23, 2005

(30) Foreign Application Priority Data
Sep. 10, 2004 (JP) 2004-264435

(51) Int. Cl. H04N 5/225

(52) U.S. Cl. 348/340

(57) ABSTRACT

In optical equipment, an image pickup element is not electrically connected directly to a hard electric board, but is electrically connected thereto via a flexible printed circuit. Since the image pickup element and the hard electric board are electrically connected via the flexible printed circuit, thermal effect of soldering or effect of deformation of the hard board can be alleviated. Since the flexible printed circuit has flexibility, the image pickup element can easily be positioned at an accurate position at the time of assembly. Also, it can hardly be affected by aged deformation.

### CROSS-REFERENCE TO RELATED APPLICATION

This application is based upon and claims the benefit of priority from prior Japanese Patent Application No. 2004-264435, filed Sep. 10, 2004, the entire contents of which is incorporated herein by reference.

### BACKGROUND OF THE INVENTION

1. Field of the Invention

The present invention relates to optical equipment (imaging device) having an image pickup element and, more specifically, to a mounting structure of the image pickup element in the optical equipment.

2. Description of the Related Art

Hitherto, there are several disclosures relating a mounting method of a solid-state image pickup element (image pickup element) of the optical equipment. For example, in JP-A-61-259599, a position adjusting apparatus for the solid-state image pickup element in a digital camera as the optical equipment is disclosed.

The position adjusting apparatus for the solid-state image pickup element disclosed in JP-A-61-259599 is configured in such a manner that the solid-state image pickup element can be mounted to a chassis so as to be capable of adjusting the position thereof. The solid-state image pickup element is mounted to a hard electric board which can be adjusted in position in a direction orthogonal to an optical axis in a state of sandwiching a heat-discharging shield plate and an insulating sheet. The solid-state image pickup element in this mounting state is soldered to a connecting pattern section of the electric board in a state in which a lead for electric connection of the element is inserted into a through-hole on the hard electric board.

In the digital camera, for example, an image forming surface of the solid-state image pickup element is required to be positioned accurately at a predetermined distance (flange back) in the direction of the optical axis with respect to a reference plane of the chassis. In the position adjusting apparatus for the solid-state image pickup element disclosed in JP-A-61-259599, the lead of the solid-state image pickup element is directly soldered to the hard electric board.

### BRIEF SUMMARY OF THE INVENTION

The optical equipment of the invention is adapted not to electrically connect an image pickup element directly to a hard electric board, but to electrically connect thereto via a flexible printed circuit (FPC). Since the image pickup element and the hard electric board are electrically connected via the flexible printed circuit, effect of deformation of the hard electric board is alleviated. Since the flexible printed circuit has flexibility, adequate positioning of the image pickup element can easily be achieved at the time of assembly. Also, it is hardly affected by aged deformation.

For example, the hard electric board is disposed behind the image pickup element, and a lead terminal of the image pickup element is passed through an opening formed on the electric board in a non-contact state. Then, the flexible printed circuit is disposed behind the hard electric board, and the lead terminal of the image pickup element passed through the opening on the hard electric board is electrically connected to the flexible printed circuit. Then, the flexible printed circuit and the hard electric board are electrically connected at a position apart from a connecting position with respect to the lead terminal. In this structure, since the hard electric board is interposed between the image pickup element and the flexible printed circuit, a compact structure is possible. In this case, the opening can be substituted by a notch.

Alternatively, it is also possible to provide an opening (or a notch) on the flexible printed circuit, and electrically connect the flexible printed circuit and the hard electric board at an end of the opening. In this structure, a further compact structure is possible.

A different member may be disposed between the image pickup element, the hard electric board, and the flexible printed circuit. For example, the different member may be a supporting plate for fixedly supporting the image pickup element.

A printed wiring on the flexible printed circuit may be provided on one surface or both surfaces of the flexible printed circuit.

The image pickup element or the hard electric board or the flexible printed circuit may be arranged into a compact structure by disposing parallel to each other. They may also be interspaced with respect to each other.

Furthermore, an assembly including the image pickup element and the hard electric board may be assembled to a fixing member for fixing an optical system into a unit.

The invention can provide an optical device in which the image pickup element can be mounted to a position more accurately in the direction of an optical axis, and aged deformation of the mounting position is reduced.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is an exploded perspective view of a front panel unit of a digital single lens reflex camera as an optical device according to a first embodiment of the invention.

FIG. 2 is an exploded perspective view of an image pickup unit of the digital camera in FIG. 1.

FIG. 3 is a vertical cross-sectional view of a dust-proof unit and an image pickup element unit of the image pickup unit in FIG. 1 including an optical axis.

FIG. 4 is a drawing viewed in a direction indicated by an arrow in FIG. 3, showing a periphery of a lead connecting portion of the image pickup element.

FIG. 5 is a vertical cross-sectional view of a dust-proof unit and an image pickup element unit in a digital camera as an optical device including an optical axis according to a second embodiment of the invention.

FIG. 6 is a drawing viewed in a direction indicated by an arrow in FIG. 5, showing a periphery of a lead connecting portion of an image pickup element.

FIG. 7 is a drawing showing the periphery of the lead connecting portion of the image pickup element in a case in which a first modification is applied to an connecting FPC for connecting the image pickup element in the digital camera according to the second embodiment shown in FIG. 5 (corresponding to a drawing viewed in the direction indicated by an arrow in FIG. 5).

FIG. 8 is a vertical cross-sectional view of a dust-proof unit and an image pickup unit including the optical axis in a case in which a second modification is applied to the electric board and the connecting FPC for connecting the image pickup element in the digital single lens reflex camera according to the second embodiment in FIG. 5.

FIG. 9 is a drawing viewed in a direction indicated by an arrow in FIG. 8, showing a periphery of a lead connecting portion of the image pickup element.

### DETAILED DESCRIPTION OF THE PREFERRED EMBODIMENTS

Preferred embodiments of the invention are described below with reference to the accompanying drawings.

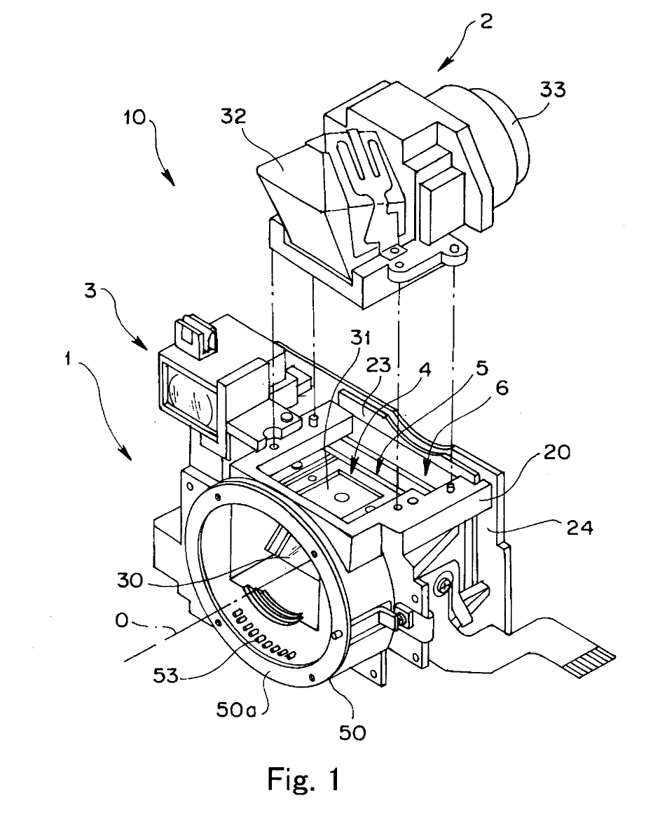

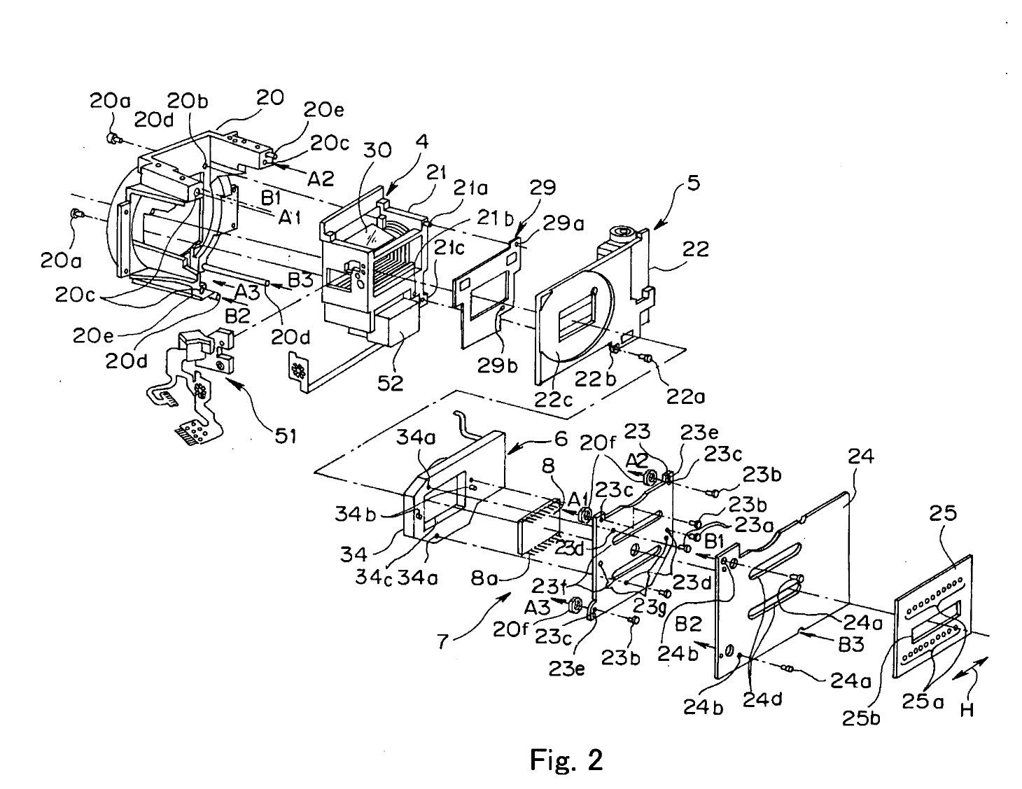

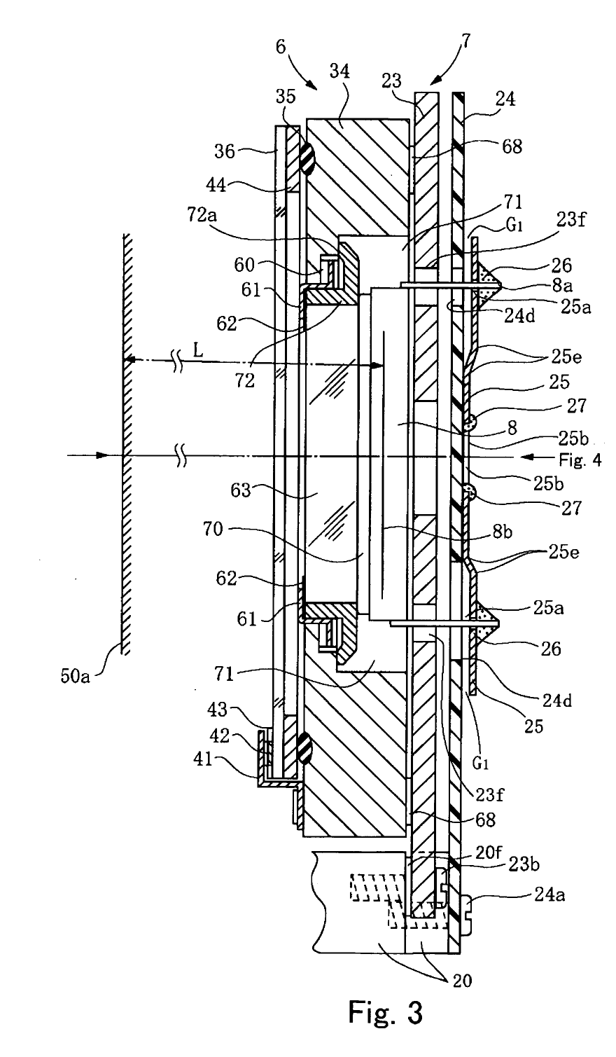

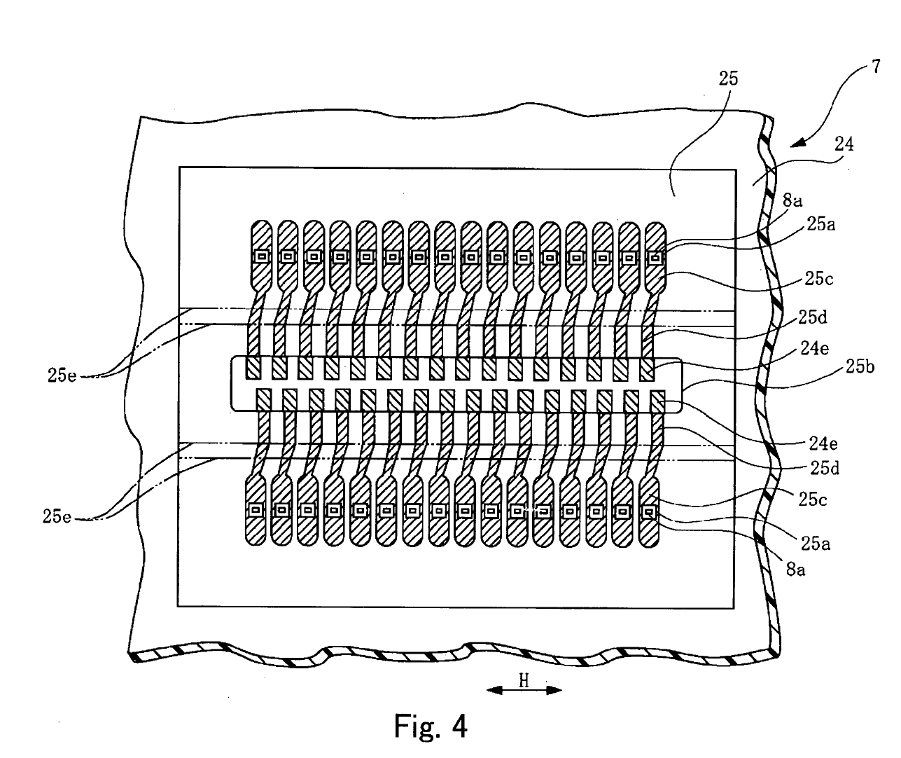

FIG. 1 is an exploded perspective view of a front panel unit of a digital single lens reflex camera as an optical device (imaging device) according to a first embodiment of the invention. FIG. 2 is an exploded perspective view of an image pickup unit of the digital camera. FIG. 3 is a vertical cross-sectional view of a dust-proof unit and an image pickup element unit of the image pickup unit including an optical axis. FIG. 4 is a drawing viewed in a direction indicated by an arrow in FIG. 3, showing a lead connecting portion of the image pickup element, provided that FIG. 4 shows a state before a conducting pattern is soldered.

In the description below, an optical axis of a photographic luminous flux of the digital single lens reflex camera according to the present embodiment is represented by an optical axis O, and a horizontal (lateral) direction which is perpendicular to the optical axis O is represented by a direction H. A side of a photographic object (a side of a barrel of an interchangeable lens) of this digital camera is referred to as a front side, and an image forming side is referred to as a rear side (a back side).

As shown in FIG. 1, a front panel unit 10 of the digital single lens reflex camera of this embodiment includes an image pickup unit 1, a finder unit 2, and an auxiliary light unit 3. The image pickup unit 1 has a mount for mounting an interchangeable lens and an image pickup section. The finder unit 2 is mounted to an upper portion of the image pickup unit 1, and includes a pentaprism 32, an ocular lens 33. The auxiliary light unit 3 is mounted to the upper portion of the image pickup unit 1 and illuminates auxiliary light for measuring the distance.

As shown in FIGS. 1 and 2, the image pickup unit 1 includes a body mount 50 disposed from the photographic object side along the optical axis O, a front frame 20 as a fixing member for supporting a photographic optical system, a mirror unit 4, a shutter unit 5, and a dust-proof unit 6, which constitute the optical system, and an image pickup element unit 7. These members are fixedly supported directly or indirectly on the front frame 20.

The members of the image pickup unit 1 will be described below.

The interchangeable lens barrel having the photographic optical system can be attached to and detached from the body mount 50, and a communication contact point 53 with respect to the lens barrel is provided on a front inner side of the body mount 50.

The mirror unit 4 includes a mirror unit frame 21, a main mirror 30 rotatably supported on a photographic optical path of the mirror unit frame 21, and a screen 31 disposed on an upper portion thereof. A photometric unit 51 is disposed on a side portion of the mirror unit frame 21, and an AF unit 52 is disposed on a lower portion thereof.

The shutter unit 5 includes a shutter frame 22, a shutter blade, and a shutter actuator arranged in the frame.

As shown in FIG. 3, the dust-proof unit 6 includes a dust-proof unit supporting base 34 having an opening 34c, a dust-proof filter 36 disposed on the supporting base, a dust-proof piezoelectric element 44, and an O-ring 35.

The image pickup element unit 7 includes optical filter 63, an image pickup element 8 having CCD or the like, an image pickup element supporting plate 23 as a supporting plate formed of aluminum or stainless steel plate, an electric board 24 having a hard printed wiring assembly, and a flexible printed wiring circuit (hereinafter, referred to as FPC) 25 for connecting the image pickup element disposed in sequence from the photographic object side.

The members of the image pickup unit 7 will be described below.

As shown in FIG. 2 and FIG. 3, the image pickup element 8 includes an image forming surface 8b on which an image of the photographic object is formed, and a plurality of leads 8a for electrical connection disposed in upper and lower two rows extending in parallel with the optical axis O in the direction of the optical axis O.

The electric board 24 is provided with an image signal processing circuit, and an image pickup system electric circuit including a work memory mounted thereon, and is a hard electric wiring board for receiving electric signals from the image pickup element 8. The electric board 24 includes elongated openings 24d extending in the direction H at upper and lower positions thereof so that the leads 8a which correspond to electrodes of the image pickup element 8 can be loosely passed through in the direction of the thickness. The electric board 24 further includes connector conducting patterns 24e corresponding to the number of the leads 8a for electrically connecting the leads 8a of the image pickup element 8 and the electric circuit on the electric board 24 (see FIG. 4).

The connecting FPC 25 includes an elongated opening 25b extending in the direction H at the center and lead insertion holes 25a arranged in upper and lower two rows along the direction H provided corresponding to the rows of the plurality of leads 8a of the image pickup element 8 as shown in FIGS. 3 and 4. The connecting FPC 25 includes first conducting patterns 25c arranged on upper and lower two rows around the lead insertion holes 25a, and second conducting patterns 25d arranged on upper and lower two rows continuously from the conducting patterns 25c and extending toward the center to the edge of the opening 25b. Provided between the upper and lower first and second conducting patterns 25c, 25d of the connecting FPC 25 are bending lines 25e extending in the direction H.

The elongated opening 25b of the connecting FPC 25 is located at a position so that the connector conducting patterns 24e of the electric board 24 are exposed at the edge of the opening 25b when placed on the electric board 24. The ends of the second conducting patterns 25d extending to the upper and lower edges of the opening 25b overlap with the connector conducting patterns 24e at the edge of the opening.

Since FPC 25 is bent along the bending lines 25e, the surfaces having the first conducting patterns 25c are held in parallel with the surface having the opening 25b and the second conducting patterns 25d with a step (corresponding to a gap G1) therebetween. In a state in which the connecting FPC 25 is soldered to the electric board 24 the peripheral portions of the first conducting patterns 25c of the FPC 25 are apart from the electric board 24, and are supported so as to be deformable in the direction of the thickness (fore-and-aft direction) of the connecting FPC 25.

In the image pickup unit 1 comprising the above-described components, as shown in FIGS. 2 and 3, the mirror unit frame 21 of the mirror unit 4 is inserted from a back side of the front frame 20 into a space defined by four columns extended from the front frame 20 in the direction of the optical axis. Then, screws 20a inserted into screw insertion holes 20b from a front side of the front frame 20 are screwed into screw holes, not shown, of the mirror unit frame 21, and the mirror unit frame 21 is fixed to the front frame 20.

Holes 29a, 29b of a shutter base plate protecting sheet 29 are aligned with projections 21a, 21b provided on a back side of the mirror unit flame 21, so that the shutter base plate protecting sheet 29 is held between the mirror unit frame 21 and the shutter unit 5. Then, a screw 22a inserted into a screw insertion hole 22b from a rear side of the shutter frame 22 of the shutter unit 5 is screwed into a screw hole 21c of the mirror unit frame 21. Accordingly, the shutter frame 22 is fixed to the mirror unit frame 21 with the intermediary of the shutter base plate protecting sheet 29. The shutter base plate protecting sheet 29 mainly serves as a mask or an aperture which determines required luminous flux for the photographic object, and also has a protecting function for protecting the shutter base plate from unnecessary external light.

The supporting base 34 of the dust-proof unit 6 is disposed in a substantially circular recess 22c on the rear side of the shutter frame 22 in a state of being aligned with the dust-proof filter 36 which is a part of the dust-proof unit 6. Since a diameter of the recess 22c is substantially the same as a diameter of the dust-proof filter 36, both of them are fitted to each other substantially hermetically. With this structure as well, foreign particles or dust are restrained from attached to a filter surface.

The supporting base 34 of the dust-proof unit 6 is mounted to the image pickup element supporting plate 23 while being kept in position by a receiving portion 68 provided on the supporting base 34 or the supporting plate 23. Then, a protecting glass 70 and the optical filter (low-pass filter) 63 are arranged on the front surface of the image pickup element 8. A peripheral edge of the optical filter 63 is covered by a dust-proof member 72 formed of rubber material. Foreign particles or dust in a space 71 are prevented from entering into the front surface of the optical filter 63 by bringing an abutting portion 72a of the dust-proof member 72 into abutment with an inner surface of the supporting base 34. Furthermore, the foreign particles or dust in the space 71 is prevented from entering into the front side of the protecting glass 70 and the rear side of the optical filter 63 by bringing the dust-proof member 72 into tight contact with the protecting glass 70.

The optical filter 63 and the dust-proof member 72 receive a resilient force of a spring member 60 toward the rear surface in the direction of the optical axis, that is, toward the image pickup element 8 in the direction of the optical axis, via a holding member 61, and is pressed toward the image pickup element 8. Disposed between the holding member 61 and the optical filter 63 is a protecting sheet 62 for protecting the optical filter 63.

In a state in which the above-described dust-proof unit 6 is mounted, the dust-proof filter 36 is vibrated by controlling a dust-proof filter drive unit at a predetermined cycle and applying a cyclic voltage to the piezoelectric element 44 provided between the optical filter 63 and the O-ring. The dust attached to the surface of the dust-proof filter 36 is removed by the vibrations.

The image pickup element 8 is secured to the image pickup element supporting plate 23 by adhesive agent in a state in which the leads 8a as the electrodes of the image pickup element 8 loosely pass through elongated openings 23f extending in the direction H on the image pickup element supporting plate 23. In the secured state described above, the image forming surface 8b of the image pickup element 8 is held in parallel with the image pickup element supporting plate 23.

The supporting frame 34 of the dust-proof unit 6 and the image pickup element supporting plate 23 are controlled in relative position by a pair of pins 34b of the supporting base 34 and a pair of holes 23g provided on the supporting plate 23, and the image pickup element 8 is inserted into the opening 34c on the supporting plate 34 from the back side. Then, screws 23a inserted into screw insertion holes 23d from the back side of the image pickup element supporting plate 23 are screwed into screw holes 34a on the supporting base 34. Accordingly the image pickup element supporting plate 23 and the image pickup element 8 are fixed to the supporting base 34 of the dust-proof unit 6. Furthermore, screws 23b inserted into screw insertion holes 23c from the back side of the image pickup element supporting plate 23 are screwed into the screw holes 20c on the front frame 20, and simultaneously, positioning holes 23e on the image pickup element supporting plate 23 are fitted on positioning projections 20e on the front frame 20. Accordingly, the image pickup element supporting plate 23 is positioned with respect to the front frame 20 and is fixed thereto.

When fixing the image pickup element supporting plate 23 to the front frame 20, distance adjusting members 20f are added and fixed to the respective positions of the screws 23b between the image pickup element supporting plate 23 and the front frame 20 in order to adjust the position of the image pickup surface of the image pickup element 8 on the optical axis. This adjustment may be made simply by adding the distance adjusting members 20f of the same thickness to the positions of the respective screws 23b if only the adjustment of the position of the image pickup surface on the optical axis is to be made. On the other hand, when the image pickup surface of the image pickup element 8 is non-parallel with a mounting surface 50a of the body mount 50 and hence the image pickup surface is to be adjusted into a parallel position, the distance adjusting members 20f having different thicknesses from each other are added to the positions of the respective screws 23b between the image pickup element supporting plate 23 and the front frame 20.

Then, as shown in FIG. 3, the electric board 24 is disposed on the back side of the image pickup element supporting plate 23 with the leads 8a of the image pickup element 8 loosely passed through the elongated openings 24d on the electric board 24. The electric board 24 is fixed to the front frame 20 by screwing screws 24a inserted into screw insertion holes 24b from the back side into the screw holes 20d on the front frame 20.

As described above, the electric board 24 is fixed to the front frame 20 with the intermediary of at least the mirror unit 4, the shutter base plate protecting sheet 29, the shutter unit 5, the dust-proof unit 6, the image pickup element 8, and the image pickup element supporting plate 23. In this mounting state, the electric board 24 is supported in parallel with the image pickup element supporting plate 23 with a predetermined gap secured therebetween. The image forming surface 8b of the image pickup element 8 is positioned at a flange back L, which is at a predetermined distance from the mounting surface 50a of the body mount 50 along the direction of the optical axis O.

At the back side of the electric board 24 in the mounting state described above, the connecting FPC 25 for connecting the image pickup element is placed with the leads 8a of the image pickup element 8 inserted through the lead insertion holes 25a of the FPC 25. As shown in FIGS. 3 and 4, the connecting FPC 25 for connecting the image pickup element is placed with the opening 25b at the center aligned with the range of the connector conducting patterns 24e on the electric board 24.

The leads 8a of the image pickup element 8 in the inserted state and the first conducting patterns 25c of the connecting FPC 25 are soldered to each other by solder 26. In addition, the connector conducting patterns 24e of the electric board 24 exposed from the opening 25b of the connecting FPC 25 and the second conducting patterns 25d of the connecting FPC 25 are soldered with solder 27 (FIG. 3). With this soldering, the image pickup element 8 is electrically connected to the image pickup system electric circuit on the electric board 24 via the connecting FPC 25.

In the above-described board mounting state, the side of the second conducting patterns 25d at the edge of the opening 25b of the connecting FPC 25 is brought into a tight-contact state with the electric board 24. However, since the connecting FPC 25 is bent, the sides of the first conducting patterns 25c are held in the state of lifting from the surface of the electric board 24 by the gap G1, which is a minute gap, and in parallel with the electric board 24. Therefore, the first conducting patterns 25c of the connecting FPC 25 and the periphery thereof are supported on the electric board 24 in a state of being capable of moving slightly with respect to each other in the direction of the thickness with a slight force.

In the digital camera according to the first embodiment in the arrangement as described above, an image of the photographic object to be taken by the lens barrel mounted thereon, through the mirror unit 4 and the shutter unit 5, forms an image on the image forming surface 8b of the image pickup element 8. The image of the photographic object is converted into electric signals by the image pickup element 8. Then, they are processed as image pickup signals by the image pickup system electric circuit on the electric board 24 and are outputted.

In the digital camera of the first embodiment, the leads 8a of the image pickup element 8 are soldered to the first conducting patterns 25c of the connecting FPC 25. In this state, the portion having the first conducting pattern 25c secures the gap G1 with respect to the hard electric board 24, and is supported in a state of being capable of deforming easily in the direction of the optical axis O (in the fore-and-aft direction). Therefore, in comparison with a case of soldering directly to the electric board 24 as in the related art, the electric board 24 is not subject to deformation due to thermal deformation at the time of soldering. Even when a force with respect to the leads 8a in the direction of the optical axis O is generated due to shrinking of solder occurred when cured from a melted state, the change can hardly affect the leads 8a. Therefore, the image forming surface 8b of the image pickup element 8 is avoided from changing slightly in the direction of the optical axis O, and hence the change of the flange back L can be restrained. In addition, since the deformation of the electric board 24 due to the aged deterioration is absorbed by the flexible connecting FPC 25, the aged deformation of the flange back L can be restrained.

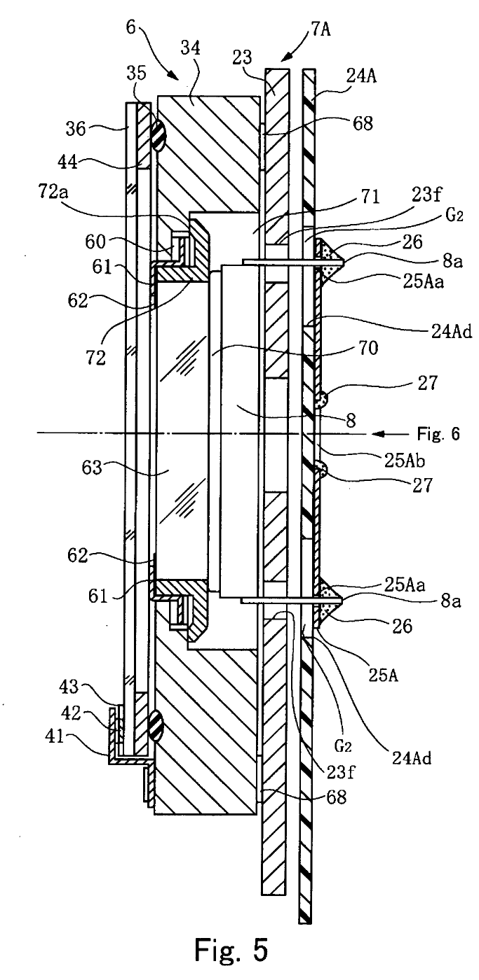

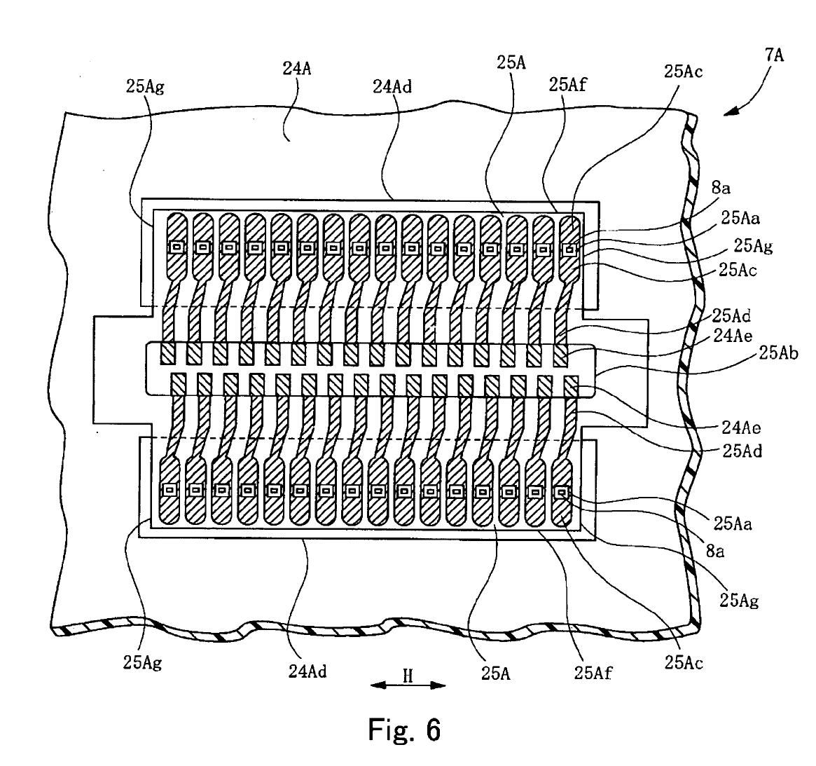

Subsequently, referring to FIGS. 5 and 6, a digital single-lens reflex camera as optical equipment according to a second embodiment of the invention will be described.

FIG. 5 is a vertical cross-sectional view of a dust-proof unit and an image pickup element unit in the digital single lens reflex camera in this embodiment including an optical axis. FIG. 6 is a drawing viewed in a direction indicated by an arrow in FIG. 5, showing a periphery of a lead connecting portion of an image pickup element, provided that FIG. 6 shows a state before a soldering of a conducting pattern is performed.

The digital single lens reflex camera in this embodiment is different from the digital camera in the first embodiment described above in mounting structure with respect to the electric board of the image pickup element, and other structures are equivalent. Therefore, the same components are represented by the same reference numerals and only the different parts will be described below.

As shown in FIGS. 5 and 6, components of an image pickup element unit 7A in the digital camera of this embodiment are arranged in sequence from the side of the photographic object. The image pickup element unit 7A includes the image pickup element 8 which is an image pickup element including the optical filter 63 and the CCD, and the image pickup element supporting plate 23 which is a supporting plate formed of aluminum or stainless steel plate or the like as in the case of the first embodiment. The image pickup element unit 7A includes an electric board 24A having a hard printed wiring assembly which is different from the one in the first embodiment, and a connecting FPC 25A for connecting the image pickup element which is different from the one in the first embodiment.

The electric board 24A is a hard electric wiring board which includes an image pickup system electric circuit having an image signal processing circuit, work memory, and so on is mounted, and receives electric signals from the image pickup element 8. The leads 8a as the electrodes of the image pickup element 8 are inserted through the electric board 24A in the direction of the thickness in a state of remaining a relatively large room. In addition, the electric board 24A includes elongated openings 24Ad at upper and lower two positions extending in the direction H, and connector conducting patterns 24Ae corresponding to the number of the leads 8a in order to electrically connect the leads 8a of the image pickup element 8 and the electric circuit on the electric board 24A.

The connecting FPC 25A includes an elongated opening 25Ab extending at the center in the direction H and lead insertion holes 25Aa arranged in upper and lower two rows along the direction H corresponding to the rows of the plurality of leads 8a of the image pickup element 8 as shown in FIG. 6. Furthermore, the connecting FPC 25A includes a first conducting patterns 25Ac arranged in upper and lower two rows to be disposed around the lead insertion holes 25Aa, and a second conducting patterns 25Ad arranged in upper and lower two rows continuously from the conducting patterns 25Ac and extending toward the center to the edge of the opening 25Ab. The connecting FPC 25A does not require a bending portion.

The elongated opening 25Ab is located at a position such that when the connecting FPC 25A is placed on the electric board 24A, the connector conducting patterns 24Ae of the electric board 24A are exposed at the edge of the opening 25Ab. Then, the ends of the second conducting patterns 25Ad extending to the upper and lower edges of the opening 25Ab are overlapped with the connector conducting patterns 24Ae at the edge of the opening 25Ab.

Furthermore, outer left and right side portions 25Ag and outer upper and lower side portions 25Af around the upper and lower first conducting patterns 25Ac of the conducting FPC 25A (that is, the peripheral portion of the upper and lower first conducting patterns 25Ac) are located just above the openings 24Ad of the electric board 24A, respectively. Therefore, the peripheral portion of the first conducting patterns 25Ac of the connecting FPC 25A may be deformed in the direction of the thickness (fore-and-aft direction) of the electric board 24A, and the connecting FPC 25A. The openings 24Ad of the electric board 24A define gaps G2.

In the image pickup element unit 7A having the structure as described above, when the image pickup element 8 is electrically connected to the electric board 24A the connecting FPC 25A is placed on the back side of the electric board 24A in a state of being mounted to the front frame 20 as in the case of the first embodiment. In this case, as shown in FIGS. 5 and 6, the opening 25Ab at the center of the connecting FPC 25A is aligned with the range of the connector conducting patterns 24Ae of the electric board 24A, and the leads 8a of the image pickup element 8 are inserted into the lead insertion holes 25Aa.

Then, the leads 8a of the image pickup element 8 in the inserted state and the first conducting patterns 25Ac of the connecting FPC 25A are soldered with the solder 26. Furthermore, the connector conducting pattern 24Ae of the electric board 24A exposed from the opening 25Ab and the second conducting patterns 25Ad of the connecting FPC 25A are soldered with the solder 27 (FIG. 5). With this soldering, the image pickup element 8 is electrically connected to the image pickup system electric circuit on the electric board 24A via the FPC 25A.

In the above-described board mounting state, the connecting FPC 25A is brought into tight-contact with the electric board 24A. However, the peripheral portion of the first conducting patterns 25Ac is positioned within the openings 24Ad on the electric board 24A, and is held at least in a state in which the gaps G2 which correspond to the thickness of the board are secured by the openings 24Ad. Therefore, the first conducting pattern 25Ac of the connecting FPC 25A and the peripheral portion thereof are both supported on the electric board 24A in a state of being capable of moving slightly with respect to each other in the direction of thickness with a slight force.

In the digital camera according to the second embodiment as well, the FPC portion of the first conducting pattern 25Ac secures a gap with respect to the hard electric board 24A as in the case of the first embodiment, and is supported in a state of being capable of deforming easily in the direction of the optical axis O. Therefore, the force generated by thermal deformation of the electric board 24 at the time of soldering can hardly affect the leads 8a, and hence the change of the flange back L is extremely reduced. In addition, the aged variation of the flange back L can also be restrained. Furthermore, since the bending portion is not necessary for the connecting FPC 25A, the required space for the image pickup element unit 7A in the direction of the optical axis O is small in comparison with the case of the first embodiment, and moreover, the soldering work can be performed easily.

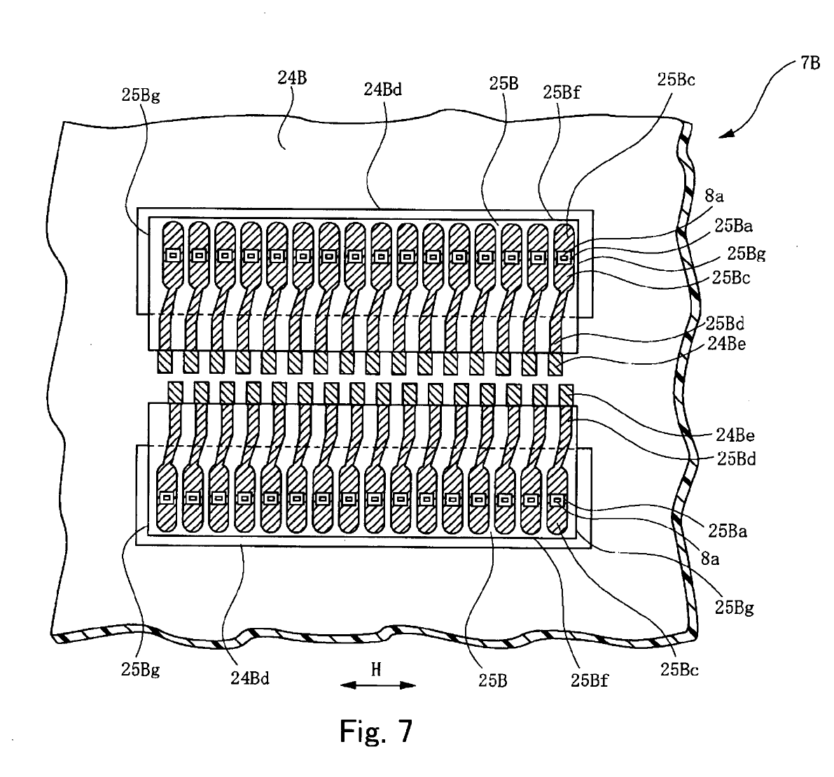

Subsequently, referring to FIG. 7, a first modification of the connecting FPC 25A for connecting the image pickup element which is applied to the digital camera according to the above-described second embodiment will be described.

FIG. 7 is a drawing showing the portion around the lead connecting portion of the image pickup element in the case where this modification is applied (corresponding to a drawing viewed in the direction indicated by an arrow in FIG. 5), provided that FIG. 7 shows a state before soldering of the conducting pattern is performed.

In a connecting FPC 25B for connecting the image pickup element in this modification, a FPC which is divided into upper and lower halves as shown in FIG. 7 instead of the connecting FPC 25A in the second embodiment shown in FIG. 6. The divided upper and lower connecting FPCs 25B have the identical shape, and are shaped like the connecting FPC 25A cut apart at the opening 25Ab

An electric board 24B applied has the same shape as the electric board 24A in the second embodiment, and includes elongated openings 24Bd at upper and lower two positions extending in the direction H and connector conducting patterns 24Be corresponding to the number of the leads 8a.

The upper or lower connecting FPC 25B includes lead insertion holes 25Ba extending in the direction H shown in FIG. 7, first conducting patterns 25Bc, and second conducting patterns 25Bd extending to the edge as in the case of the connecting FPC 25A in the second embodiment.

Furthermore, the second conducting patterns 25Bd extending to the edge as in the case of the second embodiment overlap with the connector conducting patterns 24Be of the electric board 24B at the edge described above when the connecting FPC 25B is placed on the electric board 24B.

Outer left and right side portions 25Bg and outer upper and lower side portions 25Bf around the first conducting patterns 25Bc of the connecting FPC 25B are located just above the opening 24Bd of the electric board 24B, respectively. Therefore, the peripheral portion of the first conducting pattern 25Bc can be deformed in the direction of the thickness (fore-and-aft direction) with a slight force.

In an image pickup element unit 7B having the arrangement described above, in the case where the image pickup element 8 is electrically connected to the electric board 24B, the leads 8a of the image pickup element 8 in the inserted state and the first conducting patterns 25Bc of the connecting FPC 25B are soldered with the solder 26 as in the case of the second embodiment. Then, the connector conducting pattern 24Be of the electric board 24B exposed from the edge of the connecting FPC 25B and the second conducting pattern 25Bd of the connecting FPC 25B are soldered with the solder 27. With this soldering, the image pickup element 8 is electrically connected to the image pickup system electric circuit of the electric board 24B via the FPC 25B.

In the above described board mounting state, the upper and lower connecting FPCs 25B come into tight contact with the electric board 24B respectively as in the case of the second embodiment. However, the peripheral portion of the first conducting patterns 25Bc is positioned within the openings 24Bd of the electric board 24B, and is held in a state in which the gaps corresponding to the thickness of the board defined by the openings 24Bd are secured. Therefore, the first conducting patterns 25Bc of the connecting FPC 25B and the peripheral portion thereof are supported with respect to the electric board 24B in a state of being capable of moving slightly with respect to each other in the direction of thickness with a slight force.

In the case where the connecting FPC 25B in this first modification is applied, the same effects as in the second embodiment are achieved. In particular, since small components and common members can be used as the upper and lower connecting FPCs 25B, it is beneficial in cost of the components or in management.

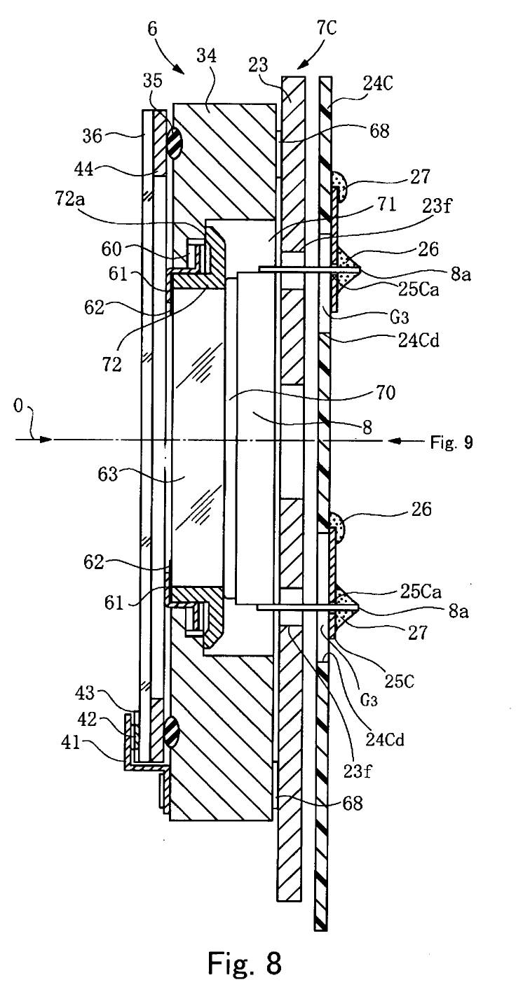

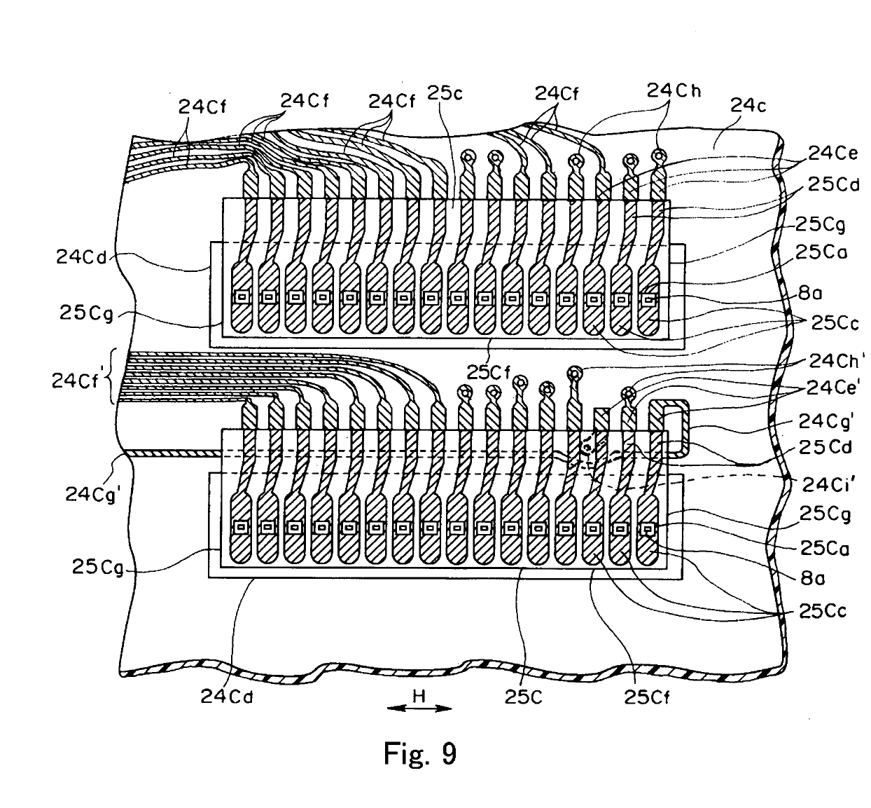

Subsequently, referring to FIGS. 8 and 9, a second modification for the electric board 24A and the connecting FPC 25A for connecting the image pickup element which are applied to the digital camera according to the second embodiment described above will be described.

FIG. 8 is a vertical cross-sectional view showing the dust-proof unit and the image pickup element unit including the optical axis in a case where this modification is applied. FIG. 9 is a drawing viewed in the direction of an arrow in FIG. 8, showing the periphery of the lead connecting portion of the image pickup element, provided that FIG. 9 shows a state before soldering of the conducting pattern is performed.

An image pickup element unit 7C in this modification, an electric board 24C as a hard electric board and a connecting FPC 25C for connecting the image pickup element are applied as shown in FIG. 8.

The electric board 24C has the same shape as the electric board 24A in the second embodiment as a contour thereof, and includes elongated openings 24Cd at upper and lower two positions extending in the direction H and connector conducting patterns 24Ce, 24Ce′ corresponding to the number of the leads 8a. Then, various patterns as communication patterns for electrically connecting the connector conducting patterns 24Ce, 24Ce′ and the electric circuit are formed.

In other words, some of the connector conducting patterns 24Ce disposed on the upper side as shown in FIG. 9 are connected to communication patterns 24Cf passing over the surface of the electric board 24C (back surface on the image pickup element unit 7C), while some them are connected to communication patterns (not shown) on the side of the rear surface (front surface on the image pickup element unit 7C) of the electric board 24C via through holes 24Ch. On the other hand, some of the connector conducting patterns 24Ce′ disposed on the lower side are connected to communication patterns 24Cf′ passing over the surface of the electric board 24C, while some them are connected to communication patterns (not shown) on the back side of the electric board 24C via through holes 24Ch′, and some of them are connected to communication patterns 24Cg′ passing on the back side of the connecting FPC 25C, described later, on the surface of the electric board 24C. Furthermore, some of them are connected to communication patterns (not shown) on the back side of the electric board 24C via through holes 24Ci′ formed on the back side of the connecting FPC 25C described later, on the surface of the electric board 24C.

The connecting FPC 25C applied here is the FPC having the same shape as the upper and lower connecting FPCs 25B in the second modification shown in FIG. 7, provided that the upper and lower connecting FPCs 25C are arranged in the same orientation as shown in FIG. 9, and second conducting patterns 25Cd are disposed on the upper side of the first conducting patterns 25Cc in both of the upper and lower connecting FPCs 25C in the case of this modification.

In the image pickup element unit 7C having the arrangement as described above, when the image pickup element 8 is electrically connected to the electric board 24C, the leads 8a of the image pickup element 8 in the inserted state and the first conducting patterns 25Cc of the connecting FPC 25C are soldered as in the case of the second embodiment. In addition, the connector conducting patterns 24Ce, 24Ce′ of the electric board 24C and the second conducting patterns 25Cd of the connecting FPC 25C are soldered. By this soldering, the image pickup element 8 is electrically connected to the image pickup system electric circuit of the electric board 24C via the FPC 25C.

In the board mounting state described above, the upper and lower connecting FPCs 25C are brought into tight contact with the electric board 24C respectively as in the case of the second embodiment. Then, the peripheral portions of the first conducting patterns 25Cc are located within the openings 24Cd of the electric board 24C, and are held with gaps G3 corresponding to the thickness of the board at least at the openings 24Cd secured. Therefore, the leads 8a of the image pickup element 8 are supported on the electric board 24C in a state in which the first conducting patterns 25Cc of the connecting FPC 25C and the peripheral portion thereof are both supported so as to be capable of moving slightly with respect to each other in the direction of thickness with a slight force.

In the case where the electric board 24C and the connecting FPC 25C in the second modification are applied, the same effects as in the second embodiment and the first modification are achieved. In particular, the connector conducting patterns 24Ce, 24Ce′, disposed on the electric board 24C and the communication patterns with respect to the electric circuit can be arranged in good space efficiency.

Also, according to the present invention, the electric board 24 is disposed on the rear side of the optical axis of the image pickup element supporting plate 23, and after having mechanically fixed to the front panel of the image pickup element, the board can be replaced or modified without changing this fixed state. Therefore, it is convenient in terms of production.

The optical device according to the present invention enables the image pickup element to be mounted to a further accurate position, and can be used as an optical device which is less subject to aged deterioration at the mounting position.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. Optical equipment including an image pickup element for picking up an image from an optical system comprising:
a fixing member for supporting the optical system for image pickup;
the image pickup element including leads for electrical connection, the leads extend in parallel with an optical axis of the optical system;
a supporting plate for supporting the image pickup element with an image pickup surface of the image pickup element oriented in parallel with the supporting plate, allowing the leads to be loosely passed therethrough in a direction of a thickness, the supporting plate being supported by the fixing member;
a hard electric board for receiving electric signals from the image pickup element, the electric board being supported in the optical equipment and allowing the leads loosely passed therethrough in the direction of the thickness; and
a flexible printed wiring circuit being capable of sagging in the direction of the optical axis of the optical system and electrically connecting between the leads and the electric board.

2. The optical equipment according to claim 1, wherein the hard electric board is fixed to the fixing member in parallel with the supporting plate.

3. The optical equipment according to claim 1, wherein the flexible printed wiring circuit is disposed in parallel with the hard electric board.

4. The optical equipment according to claim 1, wherein the supporting plate and the hard electric board are supported by the fixing member at a distance from each other.

5. The optical equipment according to claim 1, wherein the hard electric board and the flexible printed wiring circuit are connected at a distance from each other.

6. The optical equipment according to claim 1, wherein a distance adjusting member is provided between the fixing member and the supporting plate.

7. The optical equipment according to claim 1, wherein the hard electric board is arranged on a rear side of the optical axis with respect to the supporting plate.

8. The optical equipment according to claim 1, wherein the hard electric board is formed with a opening at a portion facing a connecting portion between the flexible printed wiring circuit and the leads.

9. The optical equipment according to claim 1, wherein the fixing member comprises a lens mount disposed thereon.

10. The optical equipment according to claim 1, wherein the optical equipment is a single lens reflex camera.

11. Optical equipment including an image pickup element for picking up an image from an optical system comprising:
a fixing member for supporting the optical system for image pickup;
a supporting plate for supporting the image pickup element and being supported by the fixing member;
a hard electric board arranged in parallel with the supporting plate for receiving electric signals from the image pickup element and having holes through which leads are loosely passed in a direction of a thickness thereof; and
a flexible printed wiring circuit being capable of sagging in a direction of extension of the leads for electrically connecting the leads and the electric board.

12. The optical equipment according to claim 11, wherein the hard electric board is fixed to the fixing member in parallel with the supporting plate.

13. The optical equipment according to claim 11, wherein the flexible printed wiring circuit is arranged in parallel with the hard electric board.

14. The optical equipment according to claim 11, wherein the supporting plate and the hard electric board are supported by the fixing member at a distance from each other.

15. The optical equipment according to claim 11, wherein the hard electric board and the flexible printed wiring circuit are connected at a distance from each other.

16. The optical equipment according to claim 11, wherein a distance adjusting member is provided between the fixing member and the supporting plate.

17. The optical equipment according to claim 11, wherein the hard electric board is arranged on a back side of an optical axis with respect to the supporting plate.

18. The optical equipment according to claim 11, wherein the hard electric board is formed with a opening at a portion facing a connecting portion between the flexible printed wiring circuit and the leads.

19. The optical equipment according to claim 11, wherein the fixing member comprises a lens mount disposed thereon.

20. The optical equipment according to claim 11, wherein the optical equipment is a single lens reflex camera.
